(19) United States
(12) Patent Application Publication
(10) Pub. No.: US 2017/0351866 A1
(43) Pub. Date: Dec. 7, 2017

(54) AUTHENTICATION METHOD

(71) Applicant: VERTICAL SOFTWARE ASIA PTE LTD, Singapore (SG)

(72) Inventors: Kian Hwa GOH, Singapore (SG); Chun Wei Shaun TAN, Singapore (SG)

(21) Appl. No.: 15/533,559

(22) PCT Filed: Apr. 11, 2015
(86) PCT No.: PCT/SG2015/050434

§ 371 Date: Jun. 6, 2017

(30) Foreign Application Priority Data
Dec. 6, 2014 (SG) 10201408159T

(51) Int. Cl. G06F 21/62; G06F 21/31; G06Q 20/40; H04L 29/06

(52) U.S. Cl. CPC G06F 21/6209; H04L 29/06755; G06F 21/31; G06Q 20/40

(57) ABSTRACT

Described herein is a method comprising obtaining a user identifier code associated with a document and receiving a password from a user. The method further comprising authenticating the user identifier code with the password and applying an image to the document in response to the identifier code and the password being authenticated.

### TECHNICAL FIELD

The present invention relates generally to an authentication method and an authentication system for application thereof.

### BACKGROUND

Rubber stamps for the purpose of authenticating documents in the real world are still a commonplace despite the fact that electronic solutions of document processing and signature exist. A problem arises in the real world is that no single company is able to introduce a method of document authenticity verification. Which has resulted in companies not being able to be truly paperless because in certain business process, documents still need to be verified with a company chop using a rubber stamp. Accordingly, there is a need for a solution to the foregoing issue.

### SUMMARY

In accordance with a first aspect of the invention, there is disclosed an authentication method comprising obtaining a user identifier code associated with a document by a computing device and receiving a password from a user by the computing device. The authentication method further comprising authenticating the user identifier code with the password and applying an image to the document by the computing device in response to the user identifier code and the password being authenticated, with the image being associated with the user identifier code.

In accordance with a second aspect of the invention, there is disclosed a machine-readable medium having scored therein a plurality of programming instructions, which when executed, the instructions cause the machine to obtain a user identifier code associated with a document by a computing device and receive a password from a user by the computing device. The plurality of programming instructions, which when executed, the instructions further causes the machine to authenticate the user identifier code with the password and apply an image to the document by the computing device in response to the user identifier code and the password being authenticated, with the image being associated with the user identifier code.

### BRIEF DESCRIPTION OF THE DRAWINGS

For a better understanding of the present disclosure, non-limiting and non-exhaustive embodiments are described in reference to the following drawings. In the drawings, like reference numerals refer to parts through all the various figures unless otherwise specified.

FIG. 1 shows a system diagram of an authentication system in accordance with an aspect of the invention;

FIG. 2 shows a data flow diagram of the authentication system of FIG. 1; and

FIG. 3 shows a process flow diagram of a authentication method in accordance with an aspect of the invention for implementation by the authentication system of FIG. 1.

### DETAILED DESCRIPTION

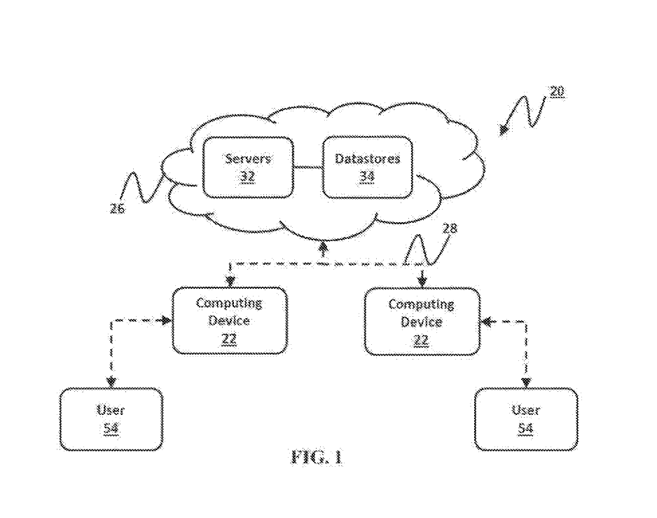

An exemplary embodiment of the present invention, an authentication method 100 utilising an authentication system 20, is described hereinafter with reference to FIG. 1 to FIG. 3.

FIG. 1 depicts an exemplary system architecture of the authentication system 20 that can execute implementations of the present disclosure. The authentication system 20 can include a computing device 22 associated with a user, an NFC (Near Field Communication) device 24 and control computer systems 26. The computing device 22 can communicate with one or more of the control computer systems 26 over a network 28. The control computer systems 26 can each include one or more servers 32 and one or more datastores 34, respectively. In some implementations, the authentication system 20 may represent a client/server system supporting multiple computer systems (e.g., control computer systems 26) including one or more clients that are connectively coupled for communication with one another over the network 30.

The computing device 22 can represent various forms of processing devices including, but not limited to, a desktop computer, a laptop computer, a handheld computer, a personal digital assistant (PDA), a smartphone, a smart tablet, a cellular telephone, a network appliance, a camera, a smart phone, an enhanced general packet radio service (EGPRS) mobile phone, a media player, a navigation device, an email device, a game console, or a combination of any two or more of these data processing devices or other data processing devices. The computing device 22 may access application software on one or more of the control computer systems 26.

The control computer systems 26 can represent various forms of server systems including, but not limited to a web server, an application server, a proxy server, a network server, or a server farm. For example, one or more of the servers 32 can be an application server that executes software accessed by the computing device 22. In some implementations, a user can invoke applications available on one or more of the servers 32 in a web browser or a mobile application running on a client (e.g., computing device 22). Each application can individually access data from one or more repository resources (e.g., datastores 112).

In some implementations, the computing device 22 may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA). Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

The network 30 can be a large computer network, such as a local area network (LAN), wide area network (WAN), the Internet, a cellular network, or a combination thereof connecting any number of mobile clients, fixed clients, and/or servers. In some implementations, each client (e.g., computing device 22) can communicate with one or more of the control computer systems 26 via a virtual private network (VPN), Secure Shell (SSH) tunnel, or other secure network connection. In some implementations, the network 30 can include the Internet, a wireless service network and may include the Public Switched Telephone Network (PSTN). In other implementations, the network 30 may include a corporate network (e.g., an intranet) and one or more wireless access points.

The computing device 22 can establish its own session with the control computer systems 26. Each session can involve two-way information exchange between the control computer systems 26 and the computing device 22. For example, a Hypertext Transfer Protocol (HTTP) session can allow the association of information with individual users. A session can be stateful session, in which at least one of the communicating parts (e.g., the control) computer systems 26 or the computing device 22) stores information about the session history in order to be able to communicate. Alternatively, stateless communication during a stateless sessions includes independent requests with associated responses.

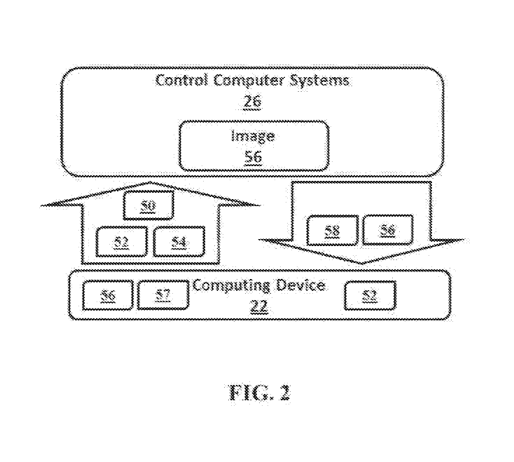

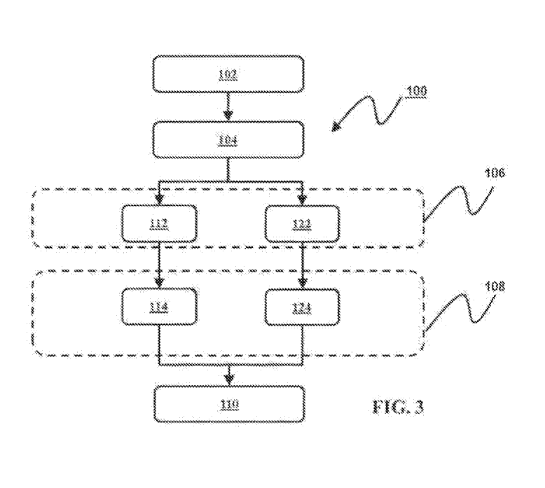

The authentication method 100, as shown in FIG. 3 and with data flow shown in FIG. 2, comprises obtaining a user identifier code 50 associated with a document 57 by the computing device 22 in a step 102. Next, a password 52 is received from a user 54 by the computing device 22 in a step 104. The user identifier code 50 is then authenticated with the password 52 in a step 106. Once the user identifier code 50 has been authenticated with the password 52 in the step 106, an image 56 is received by the computing device 22 in a step 108. The image 56 is for one of application to or association with the document 57 stored and processable by one of the computing device 22 and a system in data communication with the computing device 22 in a step 110.

The step 102 of obtaining the user identifier code 50 associated with the document 57 by a computer device 22 comprises retrieving the user identifier code 50 from a plurality of computer systems in communication with the computing device 22, the plurality of computer systems being specifically the control computer systems 26. Alternatively, the user identifier code 50 is obtained by capturing user entry thereof by the user using the computing device 22.

In a first implementation approach of the authentication method 100, the step 106 of authenticating the user identifier code 50 with the password 52 comprises sending the user identifier code 50 and the password 52 to the control computer systems 26 in a step 112. In the first implementation approach, the step 108 of receiving the image 56 by the computing device 22 comprises receiving the image 56 from the control computer systems 26 in a step 114.

In a second implementation approach of the authentication method 100, the step 106 of authenticating the user identifier code 50 with the password 52 comprises authenticating the user identifier code 50 with the password 52 by the computing device 22 in a step 122. In the third implementation approach, the step 108 of receiving the image 56 by the computing device 22 comprises receiving the image 56 from the control computer systems 26 in a step 124 in response to the identifier code 50 and the password 52 being authenticated.

In any of the implementation approaches, the image 56 may require decryption using the password 52 provided by the user 54 prior to use thereof with the document 37. Decryption of the image 56 can be achieved through use of the password 52. Alternatively, the user identifier code 50 and the password 52 may be sent to the control computer systems 56 for authentication thereby. Upon authentication of the user identifier code 50 and the password 50 by the control computer systems 26, an authentication code is sent by the control computer systems 26 to the computing device 22 for use in decrypting the image 56. Depending on implementation, the authentication code may be used in isolation or in combination with one or more of the user identifier code 50 and the password 52 for decrypting the image 56.

It is also herein disclosed that the invention can be implemented as a machine-readable medium having stored therein a plurality of programming instructions, which when executed, the instructions cause the machine to obtain the user identifier code 50 associated with the document 57 by the computing device 22 and receive the password 52 from the user 54 by the computing device 22. The plurality of programming instructions, which when executed, the instructions further causes the machine to authenticate the user identifier code 50 with the password 52 and apply the image 56 to the document 57 by the computing device 22 in response to the user identifier code 50 and the password 52 being authenticated, with the image 56 being associated with the user identifier code 50.

### General Application of Method and System

Further details of the present invention are provided hereinafter to the authentication method 100 and the authentication system 20 (“a system” and a “a method” respectively) that can be utilized with a variety of different portable communication devices, including but not limited to PDA's cellular phones, smart phones, laptops, table computers and other mobile devices that include cellular data service as preferable access to consumer downloadable applications. One such device could be an iPhone or Samsung S5. The portable communication device technology platform may be Apple OS, Android OS, Microsoft Windows mobile, Microsoft Windows Phone 7, RIM Blackberry OS, Samsung Tizen, Symbian, Java or any other technology platform. For the purposes of this disclosure, the present invention has been generally described in accordance with features and interfaces that are optimized for a smart phone utilizing a general platform that is connected to our system in the cloud, although one skilled in the art would understand that all such features and interfaces may also be used and adapted for any other platform and/or device.

A user creates an account with a unique company id on our cloud based platform. After providing authenticity of the legitimacy of the user who is authorized to create such the company id, the admin rights will be assigned to this user.

It is preferred that initiation of authentication is facilitated and controlled by the mobile application residing on the mobile communication device with the mobile application managing the first time user registration and authentication, initiation of the authentication process via the mobile application and/or via authenticated mobile application (preferably residing on another mobile communication device) and managing download and decryption of the image, for example a company stamp image, to be stored in the library residing on the mobile communication device, applied to an electronic document residing on or being accessed by the mobile communication device.

It is preferred that the mobile application and the mobile communication device constitute at least a portion of the authentication system. Further, the authentication system can further comprise the cloud-based platform which the mobile application communicates and interacts with via the mobile communication device.

Whenever the method is initiated, a second factor authentication prompt will be triggered by the library which will communicate with our platform in the cloud or embedded software library, whereby they would be required to enter their pin to verify themselves as an authorized user. This pin will be sent with the authentication id and company id for verification by the cloud-based platform.

Once authenticated, the digital image of a company stamp would be sent to the library to be superimposed onto, tagged with or merged with the document together with an optional signatory process (i.e. wet ink signature or electronic image signature). This signed document will be stored back into the cloud for archival and retrieval by verified users if connectivity is present.

### Authenticated Mobile Application

An alternative authentication method exists. A user has to pair a mobile device to the cloud platform with the company id using the mobile authentication application.

When a user selects the option of “Authentication through mobile application”, the user is prompted by the library to enter the company id into the mobile application.

A push notification will be triggered to the mobile authenticated device that is paired to the company id. This will result in an authentication process that is triggered by the system. A push notification will be sent to the mobile authenticated device. This will trigger a prompt by the application to request for an authentication pin by the user. Once the correct pin is entered into the system, the cloud platform will push the encrypted company image to the mobile application that is embedded by our library.

### Encrypted Company Stamp

When a user is successfully authenticated, a digital company stamp will be created containing the company stamp image as well as encapsulated and embedded with the name of the user that authorized the one time use of the stamp as well as timestamp.

The recreated image will be encrypted and sent to the library through the internet from the cloud platform and sent to the software library on the mobile application. Once it reaches the software library, it will be decrypted and embedded in the mobile application or mobile form.

### EXAMPLES

In an example of the application of the authentication system, specifically with use of the authentication method, a logistic truck driver carries a tablet containing a mobile application that is embedded with our software library. Here, the tablet functions as the mobile communication device as aforementioned.

When he reaches the customer's place, he will launch the application requesting for the customer's signature and company stamp. The mobile application will present the relevant document, for example a delivery order (DO), for endorsement by the customer. The document will have an associated user identifier code that is retrievable by the tablet (i.e. the computing device) through, for example, a cloud-based system (i.e. the control computer systems).

The customer has pre-registered for use of the authentication method and will be provided with a password with an associated user identifier code. The customer would also have provided an image of the stamp (i.e. company stamp) for upload to the cloud-based system.

The cloud-based system may provide specific software applications for instantaneous generation or design of the image should the image be unavailable for upload to the cloud-based system. The mobile application will prompt the customer (i.e. the user) for a password which the customer will enter for capture by the tablet. The password is authenticated with the user identifier code by either the tablet or the cloud-based system.

Once positively authenticated, an image containing the corresponding company stamp is sent from the cloud-based system to the tablet for application of the image to the DO. Alternatively, the image may be downloaded together with the DO from the cloud-based system onto the tablet prior to capture of the password from the customer. The image will be decrypted and applied to the DO only upon successful capture and authentication of the password. Further alternatively, the user identifier code may be provided by the customer instead of being retrieve automatically based on association with the DO. The mobile application may further request capture of the customer's signature based on preference. The final DO endorsed with the image of the company stamp may be sent to the cloud-based system for archival purpose.

In another example of the application of the authentication system, specifically with use of the authentication method in a B2C context, a healthcare personnel at a medical facility carries a smart device containing a mobile application that is embedded with our software library. Here, the smart device functions as the mobile communication device as aforementioned.

When the healthcare personnel approaches a patient, or potential patient, of the healthcare facility requesting consent for health records of the patient be made accessible by the medical facility and/or be shared by the medical facility with third party individuals or institutions, the healthcare personnel will present the consent document to the patient for endorsement. Endorsement of such consent documents are usually effected by signature. However, signatures, captured in wet-ink or a signature-pad, are ineffective against abuse and forgeries. Further, genuine consent of such documents are usually difficult to track or can remained untracked.

Hence, with the authentication method, the healthcare personnel not only presents the consent document to the patient using the smart device for capturing signature of the patient to indicate consent, but is also required to place a virtual stamp on the consent document.

Hence, in accordance with the authentication method, the healthcare personnel will launch the application requesting for the patient's signature and company stamp. The mobile application will present the relevant document, for example the consent document, for endorsement by the patient. The patient may be required to provide the user identifier code thereof to enable the relevant document to be retrieved by the smart device, or the document will have an associated user identifier code that is retrievable by the smart device tablet (i.e. the computing device) through, for example, a cloud-based system (i.e. the control computer systems).

The patient has pre-registered for use of the authentication method and will be provided with a password with an associated user identifier code. The patient would also have provided an image of the stamp (i.e. company stamp) for upload to the cloud-based system. The cloud-based system may provide specific software applications for instantaneous generation or design of the image should the image be unavailable for upload to the cloud-based system. The mobile application will prompt the patient (i.e. the user) for a password which the patient will enter for capture by the smart device tablet. The password is authenticated with the user identifier code by either the smart device or the cloud-based system.

Once positively authenticated, an image containing the corresponding personal stamp is sent from the cloud-based system to the smart device for application of the image to the consent document. Alternatively, the image may be downloaded together with the consent document from the cloud-based system onto the smart device prior to capture of the password from the patient. The image will be decrypted and applied to the consent document only upon successful capture and authentication of the password. Further alternatively, the user identifier code may be provided by the patient instead of being retrieve automatically based on association with the consent document. The mobile application may further request capture of the patient's signature based on preference. The final consent document endorsed with the image of the personal stamp may be sent to the cloud-based system for archival purpose. Further, an alert to the applying of the stamp onto the document will be sent to contact points of the patient, for example through emails or messaging communication platforms, to bring use of the stamp to the attention of the patient.

Aspects of particular embodiments of the present disclosure address at least one aspect, problem, limitation, and/or disadvantage associated with existing computer-implemented method and systems. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed structures, components, or alternatives thereof, can be desirably combined into alternative structures, components, and/or applications. In addition, various modifications, alterations, and/or improvements may be made to various embodiments that are disclosed by a person of ordinary skill in the art within the scope of the present disclosure, which is limited only by the following claims.

1. An authentication method comprising:
obtaining a user identifier code associated with a document by a computing device;
receiving a password from a user by the computing device;
authenticating the user identifier code with the password; and
applying an image to the document by the computing device in response to the user identifier code and the password being authenticated, and image being associated with the user identifier code.

2. The authentication method as in claim 1, obtained a user identifier code associated with a document by a computing device comprising one of:
retrieving the user identifier code from a plurality of computer systems in communication with the computing device and capturing user data entry of the user user identifier code by the user using the computing device.

3. The authentication method as in claim 1, applying an image to the document by the computing device comprising:
one of application to or association of the image with a document stored and processable by one of the computing device and a system in data communication with the computing device.

4. The authentication method as in claim 1, authenticating the identifier code with the password comprising:
sending the user identifier code and the password to a plurality of computer systems for authentication thereby.

5. The authentication method as in claim 4, receiving an image by the computing device in response to the identifier code and the password being authenticated comprising:
receiving the image from the plurality of computer systems.

6. The authentication method as in claim 4, authenticating the identifier code with the password further comprising:
receiving an authentication code from the plurality of computer systems by the computing device in response to the user identifier code and the password being authenticated

7. The authentication method as in claim 6, authenticating the user identifier code with the password, further comprising:
decrypting the image using the authentication code by the computing device for subsequent application of the image to the document.

8. The authentication method as in claim 1, authenticating the user identifier code with the password comprising:
authenticating the user identifier code with the password by the computing device.

9. The authentication method as in claim 3, further comprising:
decrypting the image using the password by the computing device for subsequent application of the image to the document.

10. A machine-readable medium having stored therein a plurality of programming instructions, which when executed, the instructions cause the machine to:
obtain a user identifier code associated with a document by a computing device;
receive a password from a user by the computing device:
authenticate the user identifier code with the password; and
apply an image to the document by the computing device in response to the user identifier code and the password being authenticated, the image being associated with the user identifier code.

11. The machine-readable medium as in claim 10, wherein obtaining a user identifier code associated with a document by a computing device comprises one of:
retrieving the user identifier code from a plurality of computer systems in communication with the computing device and capturing user data entry of the user user identifier code by the user using the computing device.

12. The machine-readable medium as in claim 10, wherein applying an image to the document by the computing device comprises:
one of application to or association of the image with a document stored and processable by one of the computing device and a system in data communication with the computing device.

13. The machine-readable medium as in claim 10, further comprising:
decrypting the image using the password by the computing device for subsequent application of the image to the document.

14. The machine-readable medium as in claim 10, authenticating the identifier code with the password comprising:
sending the user identifier code and the password to a plurality of computer systems for authentication thereby;
receiving an authentication code from the plurality of computer systems by the computing in response to the user identifier code and the password being authenticated; and
decrypting the image using the authentication code by the computing device for subsequent application of the image to the document.
